(19) United States
(12) Patent Application Publication
(10) Pub. No.: US 2006/0121292 A1
(43) Pub. Date: Jun. 8, 2006

(54) Fusing of thermal-spray coatings

(75) Inventors: D. Trent Weaver, Peoria, IL (US); M. Brad Beardsley, Laura, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/007,674

(22) Filed: Dec. 8, 2004

(51) Int. Cl. C23C 4/00; B32B 15/04

(52) U.S. Cl. 428/457; 428/704; 428/702; 428/469; 427/446; 427/372.2

(57) ABSTRACT

The present disclosure provides a method of producing a wear-resistant coating. The method may include applying a coating material to a substrate material. The coating material may include a combination of iron, molybdenum, and boron. The method may further include fusing the coating material to the substrate material by heating the coating material with an arc lamp.

### U.S. GOVERNMENT RIGHTS

This invention was made with government support under the terms of Contract No. DE-FC26-01NT41054 awarded by the Department of Energy. The government may have certain rights in this invention.

### TECHNICAL FIELD

This disclosure pertains generally to coatings and, more particularly, to fused coatings including iron, molybdenum, and boron.

### BACKGROUND

Thermal-spray coatings can provide a cost-effective solution for improving equipment performance and extending material life span. Thermal-spray coatings may be used in a variety of industrial applications. For example, heavy machinery, mining equipment, gun barrels, printing equipment, engine components, medical devices, and cutting tools may each include thermal-spray coatings.

Many thermal-spray coatings have excellent wear resistance and high hardness. However, after use, all coatings may eventually fail, and therefore, better, longer-lasting coatings are needed. New coating compositions and improved processing techniques may provide the needed coatings.

One method of producing a thermal-spray coating is disclosed in U.S. Pat. No. 5,268,045, issued to Clare on Dec. 7, 1993 (hereinafter the '045 patent). The '045 patent provides a method for forming a metallurgical bond between a thermal-spray coating and a metallic surface. The method includes cleaning the metallic surface, applying a thermal-spray coating to the metallic surface, and heat treating the coating to diffuse the coating into the metallic surface.

While the method of the '045 patent may produce a bond between the coating and metallic surface, the method has several drawbacks. The coating compositions described in the '045 patent may lack suitable wetting properties with some surfaces. Further, the heat-treating processes of the '045 patent may heat both the coating and the entire substrate. The energy required to heat the surface and substrate may add significant production costs, especially when large volume materials are to be coated. Further, heat treating by this method may inadvertently alter the material properties of the underlying substrate and produce significant solidification and thermal expansion mismatch stress.

The present disclosure is directed to overcoming one or more of the problems or disadvantages in the prior art surface-coating technique.

### SUMMARY OF THE INVENTION

One aspect of the present disclosure includes a method of producing a wear-resistant coating. The method may include applying a coating material to a substrate material. The coating material may include a combination of iron, molybdenum, and boron. The method may further include fusing the coating material to the substrate material by heating the coating material with an arc lamp.

A second aspect of the present disclosure includes a method of producing a wear-resistant coating. The method may include applying a first layer of a coating material having a first composition to a substrate material using a thermal-spray process. The method may further include applying a second layer of a coating material having a second composition to the first layer using a thermal-spray process. The first layer and the second layer may be heated with an arc lamp.

A third aspect of the present disclosure includes a wear-resistant coating for a substrate. The coating may include a matrix phase, an interface region bonding the matrix phase to the substrate, and a plurality of particles dispersed in the matrix phase, wherein at least some of the particles include iron, molybdenum, and boron.

A fourth aspect of the present disclosure includes a work machine. The work machine may include at least one component having one or more wear surfaces. A wear-resistant coating may be disposed on the one or more wear surfaces of the at least one component. The coating may include a matrix phase, an interface region bonding the matrix phase to the at least one component, and a plurality of particles dispersed in the matrix phase, wherein at least some of the particles include iron, molybdenum, and boron.

### BRIEF DESCRIPTION OF THE DRAWINGS

The accompanying drawings, which are incorporated in and constitute a part of this specification, illustrate exemplary embodiments of the disclosure and, together with the written description, serve to explain the principles of the disclosed system. In the drawings:

FIG. 1 illustrates a work machine according to an exemplary disclosed embodiment.

FIG. 2 provides a diagrammatic representation of a coating and substrate according to an exemplary disclosed embodiment.

FIGS. 3a-3d illustrate a method for producing a coating according to an exemplary disclosed embodiment.

FIG. 4 provides a photomicrograph of a coating produced by an exemplary disclosed method.

FIG. 5 provides a higher-magnification photomicrograph of the coating of FIG. 4 produced by an exemplary-disclosed method.

### DETAILED DESCRIPTION

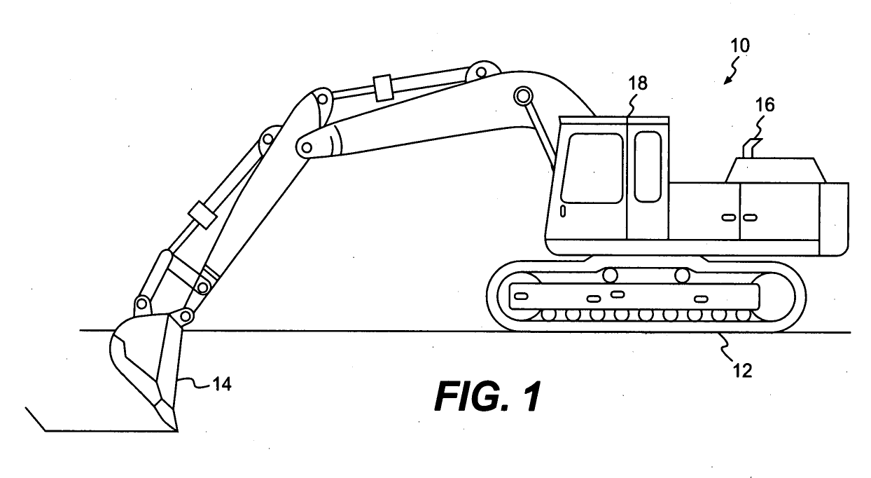

FIG. 1 illustrates a work machine 10 of the present disclosure. While work machine 10 is shown as an excavator, work machine 10 may include any type of work machine including, for example, highway vehicles, track-type tractors, loaders, skid steers, off-highway vehicles, aircraft, boats, etc. As illustrated, work machine 10 may include an undercarriage track 12, a ground-engaging tool 14, an exhaust pipe 16, and a cab rooftop 18. The coating of the present disclosure may be used in any application on work machine 10. For example, undercarriage track 12, ground-engaging tool 14, exhaust pipe 16, and/or cab roof top 18 may include the coating of the present disclosure.

Undercarriage track 12 may facilitate movement of work machine 12 and may include a number of moving parts. For example, undercarriage track 12 may include multiple bushings or track shoes (not shown). During operation of work machine 10, the bushings or track shoes may be subject to wear, which may eventually cause failure of the components. The coating may be included on one or more wear surfaces of the track shoes, bushings, or any other component of undercarriage track 12.

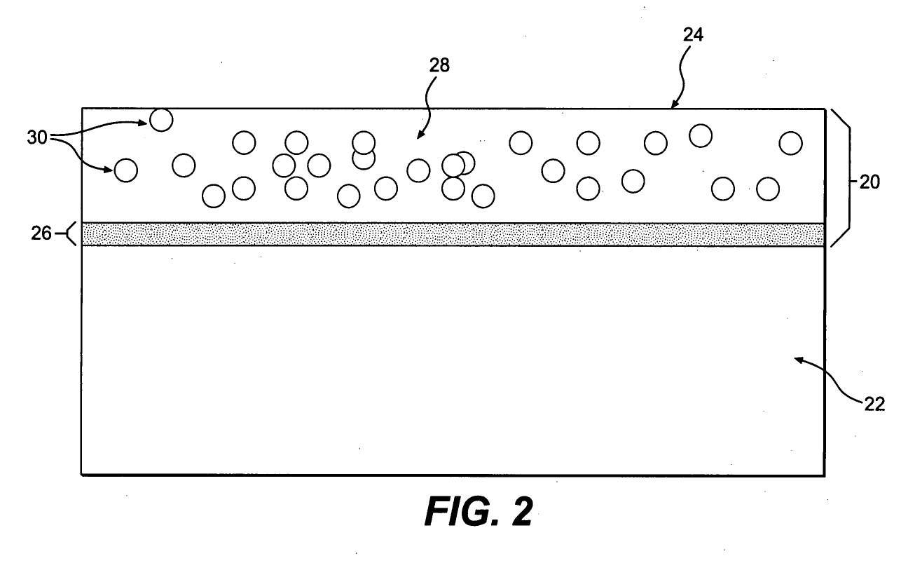

FIG. 2 provides a diagram of a coating 20 bonded to a substrate 22 according to an exemplary embodiment. Coating 20 includes a coating-substrate interface region 26 and a matrix phase 28 formed over coating-substrate interface region 26. A coating surface 24 coincides with a surface of matrix phase 28. Coating 20 may include a plurality of particles 30 dispersed in matrix phase 28.

Matrix phase 28 may be formed from any of a number of different materials. In one embodiment, matrix phase 28 may include an iron-based matrix. For example, matrix phase 28 may include steel, such as tool steel or stainless steel. In another embodiment, matrix phase 28 may include chromium (Cr) or a nickel-chromium (Ni—Cr) alloy.

Particles 30 may include any material having a hardness value that is greater than a hardness value of matrix phase 28. Particles 30 may include an alloy of iron, molybdenum, and boron (Fe—Mo—B alloy). For example, in one embodiment, particles 30 may include a molybdenum-iron boride phase with the chemical formula Mo₂FeB₂. In another embodiment, particles 30 may include an iron-boride phase and an iron-molybdenum alloy phase.

Particles 30 may comprise any desired fraction of the total weight or volume of coating 20. The amount of particles 30 in coating 20 may be selected based on the desired physical properties of coating 20. For example, a higher weight percent of particles 30 in coating 20 may provide coating 20 with increased hardness or wear-resistance. In one embodiment, particles 30 may constitute at least 20 weight % of coating 20. In another embodiment, particles 30 may constitute at least 40 weight % of coating 20. In yet another embodiment, particles 30 may constitute at least 60 weight % of coating 20. In still another embodiment, particles 30 may constitute at least 80 weight % of coating 20.

Coating 20 may be a functionally-graded material. Functionally-graded materials may include one or more physical characteristics that vary across the thickness of the material. In one embodiment, coating 20 may have a hardness that increases from coating-substrate interface region 26 to coating surface 24. The variation in physical characteristics across the thickness of coating 20 may progress continuously or in one or more steps.

Coating-substrate interface region 26 may include a metallurgical bond between matrix phase 28 and substrate 22. Particularly, coating-substrate interface region 26 may constitute a diffusion layer that includes material from matrix phase 28 and substrate 22 and effectively bonds matrix phase 28 to substrate 22. Further, the diffusion layer may include a lower concentration of particles 30 and/or a lower hardness value than the rest of coating 20.

Coating 20 may be applied to a variety of substrates 22. For example, substrate 22 may be selected from many different steel types. In one embodiment, substrate 22 may be a medium-carbon steel, such as American Iron and Steel Institute 4140 steel (AISI 4140). In another embodiment, a low or high-carbon steel may be used. Other substrate materials may be selected based on desired applications.

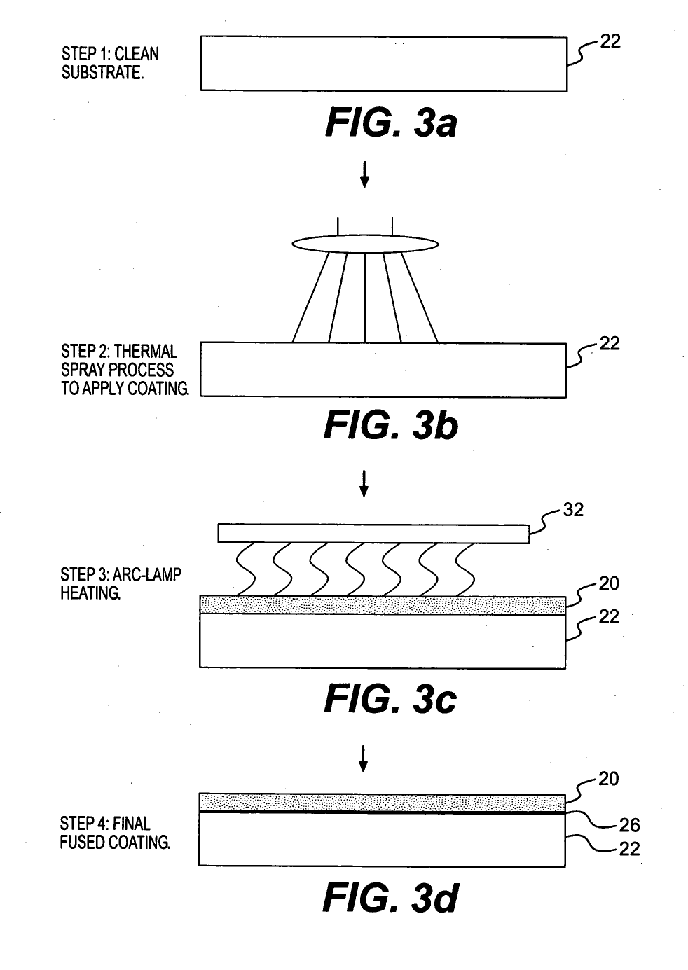

FIGS. 3a-3d illustrate a method for producing coating 20 according to an exemplary disclosed embodiment. The method may include cleaning substrate 22 (FIG. 3a), applying coating 20 (FIG. 3b), and heating coating 20 (FIG. 3c) to fuse coating 20 to substrate 22 by creating interface region 26 (FIG. 3d).

Cleaning the surface of substrate 22 before applying coating 20 may improve bonding at coating-substrate interface region 26. Cleaning may include a variety of processes. For example, substrate 22 may be degreased with a chemical solvent such as acetone. Degreasing may be followed by grit blasting with an aluminum oxide (Al₂O₃) grit. Alternatively, substrate 22 may be cleaned by an electrochemical process including alkaline and/or acidic washing. Combinations of grit blasting, degreasing, solvent washing, electrochemical cleaning, or any other suitable technique may also be used.

Coating 20 may be applied to substrate 22 using a number of application processes. These application processes may include physical and/or chemical deposition processes. For example, coating 20 may be applied using a thermal-spray process, a physical-vapor deposition process, a chemical-vapor-deposition process, and/or a spray forming process. Coating 20 may also be applied as a slurry or solution, which may be brushed or painted onto substrate 22.

As shown in FIG. 3b, coating 20, in one exemplary embodiment, may be applied to substrate 22 using a thermal-spray coating process. Thermal-spray processes can involve spraying of a molten material. In these processes, powder or wire feedstock materials may be melted by an electric arc/plasma or oxy-fuel combustion process, and the molten material may be accelerated toward substrate 22 by a flame. The resulting impact between the molten material and substrate 22 can create a layer of material on a surface of substrate 22.

A variety of thermal spray processes may be used to apply coating 20. For example, a thermal-spray process may be selected from combustion-flame spraying, high velocity oxy-fuel spraying (HVOF), two-wire electric-arc spraying, non-transferred electric-arc spraying, or plasma spraying. In one embodiment, the thermal-spray process may be selected from HVOF and plasma spraying. Any suitable thermal-spray process may be selected to apply coating 20 to substrate 22.

The thermal-spray feedstock may be provided in a number of different forms and/or compositions. In one embodiment, the feedstock may include a powder. Further, the powder may include a mixture of two or more different materials. In one embodiment, the powder may include a combination of iron, molybdenum, and boron. The combination of iron, molybdenum, and boron may also include other materials, such as steel, Cr, a Ni—Cr alloy, and/or any other suitable material.

The combination of iron, molybdenum, and boron may be provided using powders of ferroboron and ferromolybdenum stock materials. In one embodiment, a ferroboron powder may be mixed with a ferromolybdenum powder. Further, the ferroboron and ferromolybdenum powders may be mixed with yet another material, including steel, Cr, and/or a Ni—Cr alloy. Suitable Ni—Cr alloys may include between 20-80 weight % Ni and 20-80 weight % Cr.

The ferroboron and ferromolybdenum powders may be provided in a range of compositions. For example, ferroboron powders may include 10-90 weight % iron and 10-90 weight % boron. Similarly, the ferromolybdenum powders, may include between 10-90 weight % iron and 10-90 weight % molybdenum. In one embodiment, the ferroboron powders may include about 82 weight % iron and about 18 weight % boron, and the ferromolybdenum powder may include about 60 weight % iron and about 40 weight % molybdenum.

To produce an exemplary feedstock powder, the ferroboron and ferromolybdenum powders may be mixed, pressed, and sintered at a high temperature to produce an Fe—Mo—B solid. The Fe—Mo—B solid may include between about 15-85 weight % iron, 15-85 weight % molybdenum, and about 3-25 weight % boron. In one exemplary embodiment, the Fe—Mo—B solid may include 62.3 weight % iron, 28.2 weight % molybdenum, and 9.5 weight % boron.

The Fe—Mo—B solid may be crushed to produce a powder, and this powder may be mixed with another material, including steel, Cr, and/or a Ni—Cr alloy. In one embodiment, the stock material used to produce coating 20 may include from about 10 weight % and about 90 weight % of a combination of iron, molybdenum, and boron. The stock material used to produce coating 20 may further include between about 10 weight % and about 90 weight % of a second material. The second material may include a steel, Cr, or a Ni—Cr alloy. Suitable Ni—Cr alloys may include between about 20-80 weight % Ni and about 20-80 weight % Cr.

The composition of the stock material may be selected to control a number of coating properties. The iron, molybdenum, and boron content in the powder feedstock may affect substrate wetting and bonding when applied by the methods of the present disclosure. Further, the composition may be selected to control the hardness, toughness, and/or wear resistance of coating 20.

The thickness of coating 20 may be selected based on the coating use, the required life-span, and material cost. In one embodiment, coating 20 may be between about 0.2 mm and 2 mm thick.

While coating 20 may be hard and have suitable wear resistance for a variety of applications, heat treatment of coating 20 may further increase its hardness and wear-resistance properties. For example, after the thermal-spray process of FIG. 3b, coating 20 may include a certain level of porosity, which can affect its hardness, toughness, density, and/or wear resistance properties. Heat treatment may reduce the porosity of coating 20 and increase the hardness, toughness, density, and/or wear resistance of coating 20. Further, heat treatment may strengthen bonding at coating-substrate interface region 26 and/or reduce solidification stresses.

A variety of methods are available for heat treating coating 20. These methods include whole-sample heating in an inert atmosphere, torch treatment, and induction heating. Further, coating 20 may be heated using light sources such as lasers or arc lamps. Laser and/or arc lamp treatment may provide methods for rapidly and selectively treating portions of samples and/or substrates.

In one embodiment, as illustrated in FIG. 3c, coating 20 may be heated with an arc lamp 32. Arc lamp 32 can produce light by forming a high-current, voltaic arc between two electrodes. The arc may produce temperatures as high as several thousand degrees. The arc-lamp power may be controlled based on the degree of heating that is desired.

Arc lamp 32 may be selected from a number of different arc lamp designs. Arc lamp 32 may be selected based on a desired maximum power, arc lamp size, ability to focus arc-lamp energy, arc-lamp cost, and arc-lamp cooling systems. Any arc lamp having a maximum power of at least 50,000 Watts may be used to heat coating 20. In addition, arc lamp 32 may include optical reflectors to focus arc-lamp energy on a specific section of coating 20. Arc lamp 32 may also include cooling mechanisms such as flowing water to prevent overheating.

Arc lamp 32 may be positioned at a predetermined distance from coating 20. Arc lamp 32 may then be passed over coating 20, while maintaining some distance from the material. For example, arc lamp 32 may be positioned about 50 mm to 1 m from the material, and the rate of lamp movement may be selected to control heating time and degree of heating. In one embodiment, arc lamp 32 may be moved at a speed between 4 mm per second and 8 mm per second.

Arc lamp 32 may be passed over coating 20 one or more times to control the degree of heating. For example, arc lamp 32 may be passed over coating 20 from one to five times. In one embodiment, a first pass of arc lamp 32 over coating 20 may include a high movement rate with low lamp power. This first pass may preheat coating 20 to prevent excessively fast temperature changes that may damage coating 20. This first heating pass may also ensure complete heating of coating 20. The second pass may be at a lower speed and with a higher power. The second pass may melt all or part of coating 20 to facilitate bonding at coating-substrate interface region 26, while effecting material structural changes.

The specific arc-lamp power, speed, and number of passes may be selected based on the desired degree of heating of coating 20. For example, in one embodiment, a 330,000 Watt arc lamp may be used. The treatment may include two passes at 7 mm/s and 500 amps followed by one pass at 5 mm/s and 900 amps. In another embodiment, the treatment may include one pass at 7 mm/s and 500 amps, one pass at 6 mm/s and 650 amps, one pass at 5 mm/s and 900 amps, and a final pass at 6 mm/s and 400 amps.

Arc-lamp heating may facilitate bonding of coating 20 and substrate 22 at coating-substrate interface region 26. Coating-substrate interface region 26 represents a diffusion layer with a lower concentration of particles 30. The lower concentration of particles 30 in this section of coating 20 may produce a softer, more ductile coating 20, which may help reduce interface solidification and thermal expansion mismatch stresses, thereby improving coating-substrate bonding.

The arc-lamp heating process may be selected to control the degree of bonding at coating-substrate interface region 26. For example, higher-temperature or longer heat-treatment may produce a wider diffusion layer represented by coating-substrate interface region 26. The arc-lamp heating process may be selected to control the width of coating-substrate interface region 26. In one embodiment, coating-substrate interface region 26 may be between about 20 and 300 microns thick.

Ultrasonic vibrations may also be applied to substrate 22 while heating coating 20 with arc lamp 32. The ultrasonic vibrations may further aid in reducing the porosity of coating 20 by arc-lamp heating.

Coating 20 may be applied by thermal-spray processes using two or more coating compositions. In one embodiment, a first layer, having a first coating composition, may be applied using a thermal-spray process. Subsequently, a second layer, having a second coating composition, may be applied to the first layer using a thermal spray process. The first and second layers may then be heated using an arc lamp 32.

The first and second coating compositions may be selected to provide a desired physical characteristic profile in coating 20. For example, the first and second compositions may each include certain concentrations of a combination of iron, molybdenum, and boron. Further, the first and second compositions may be selected to produce a first layer having a hardness value less than the hardness value of the second layer. Particularly, the first coating composition may include a lower concentration of the combination of iron, molybdenum, and boron than the second coating composition.

### EXAMPLE

In one exemplary embodiment, a thermal-spray coating was applied to a case-hardened, low-alloy steel. The steel was degreased, grit blasted with twenty mesh Al₂O₃ grit, and cleaned with a solvent prior to spraying. The coating was sprayed with a Sulzer Metco 9 MB Series plasma-spray gun. The coating was deposited at ˜62V and ˜525 A using argon and hydrogen gases and a 110 mm stand-off distance.

The coating stock material composition included 40 weight % of an Fe—Mo—B powder and 60 weight % M4 tool steel powder. The Fe—Mo—B powder included 62.3 weight % Fe, 28.2 weight % Mo, and 9.5 weight % B.

Arc-lamp heating was performed using a 330,000 Watt arc lamp. The arc-lamp treatment included two passes at 400 A and 7 mm/s and a third pass at 900 A and 8 mm/s. There was a 25 second delay between each heating pass.

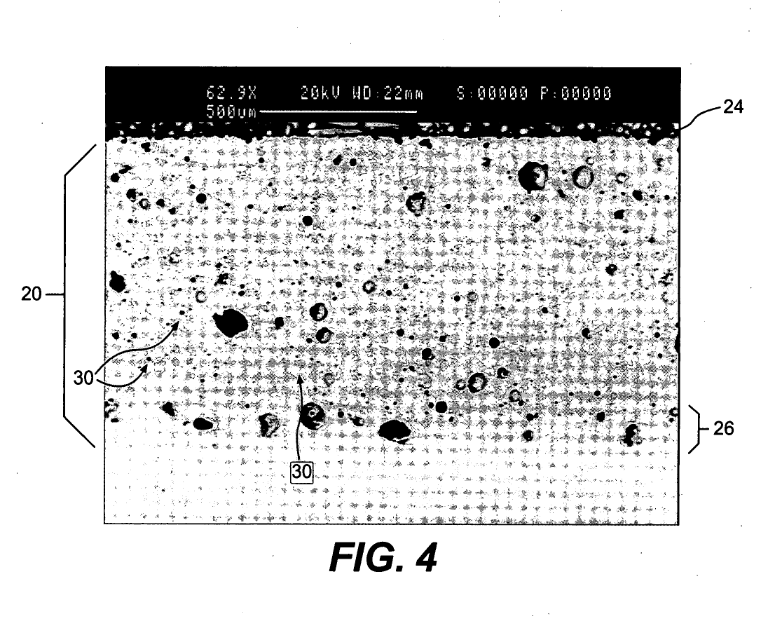

FIG. 4 is a scanning electron microscope (SEM) image of the coating prepared according to this method. The image includes surface 24 and coating-substrate interface region 26. Coating 20 includes matrix phase 28 and particles 30

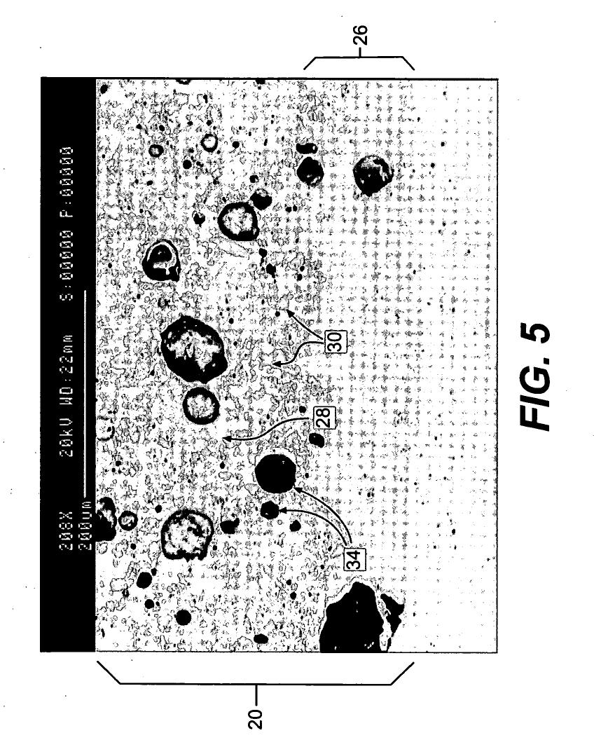

FIG. 5 provides a higher magnification SEM image of the same coating, providing a higher level of detail of coating-substrate interface region 26. The image also shows pores 34, matrix phase 28, and particles 30. In this image, coating-substrate interface 26 has a variable thickness, with a thickness from about 50 microns to 150 microns.

Particles 30 were analyzed by energy dispersive spectroscopy (EDS), and were found to include Fe and Mo. Particles 30 may include an Fe—Mo—B complex, such as MO₂FeB₂. Particles 30 may also include an Fe-boride phase and/or a molybdenum-Fe alloy phase.

Hardness Testing Data for Various Compositions of Coating 20

Arc-lamp treatment by the method of the present disclosure may increase the coating hardness and wear resistance. Numerous different coating compositions may be used, and composition and processing parameters may be selected to control coating hardness and wear resistance. For example, coating 20 may have a Vickers' hardness value between about 800 and 1400, between about 800 and 1000, or between about 1200 and 1400.

The following table provides hardness-testing data for numerous coating compositions and processing conditions. All substrate samples were cleaned and sprayed under the conditions listed in Example 1. The substrate was a case-hardened, low-alloy steel. Arc-lamp heating was performed using a 330,000 Watt arc lamp, and the heating passes were performed as listed with a 25 second delay between each heating pass.

Hardness tests were repeated ten times for each sample. Measurements represent an average with reported standard deviations.

| | | | | Vickers' |
|---|---|---|---|---|
| | | | | Hardness: |
| | | Vickers' | Vickers' | Arc Lamps Passes: |
| | | Hardness: | Hardness: | 7 mm/s @ 500 A; |
| Coating Composition | | As-sprayed | Arc Lamps Passes: | 6 mm/s @ 650 A; |
| | Fe—Mo—B | Before Arc | 2 × 7 mm/s@ 500 A; | 5 mm/s @ 900 A; |
| Matrix Content | Content | Lamp | 5 mm/a @ 900 A. | 6 mm/s @ 400 A. |
| 80 wt. % M4 | 20 wt. % FMB | 513 ± 113 | 801 ± 132 | 815 ± 125 |
| 60 wt. % M4 | 40 wt. % FMB | 565 ± 158 | 1066 ± 48 | 1056 ± 63 |
| 40 wt. % M4 | 60 wt. % FMB | 625 ± 182 | 1170 ± 61 | 1103 ± 127 |
| 20 wt. % M4 | 80 wt. % FMB | 753 ± 297 | 1236 ± 184 | 1270 ± 206 |
| 60 wt. % 316L | 40 wt. % FMB | 391 ± 124 | 567 ± 37 | 641 ± 59 |
| 40 wt. % 316L | 60 wt. % FMB | 541 ± 164 | 784 ± 109 | 854 ± 169 |
| 20 wt. % 316L | 80 wt. % FMB | 903 ± 268 | 1166 ± 186 | 1124 ± 183 |
| 40 wt. % 434L | 60 wt. % FMB | 266 ± 111 | 767 ± 127 | 663 ± 205 |
| 20 wt. % 434L | 80 wt. % FMB | 457 ± 189 | 1017 ± 202 | 973 ± 132 |
| 40 wt. % NiCr | 60 wt. % FMB | 537 ± 51 | 512 ± 77 | 467 ± 113 |
| 20 wt. % NiCr | 80 wt. % FMB | 711 ± 167 | 849 ± 128 | 879 ± 199 |
| 10 wt. % NiCr | 90 wt. % FMB | 604 ± 65 | 1146 ± 114 | 1108 ± 225 |
| 80 wt. % Cr | 20 wt. % FMB | 600 ± 82 | 638 ± 175 | 590 ± 70 |
| 60 wt. % Cr | 40 wt. % FMB | 658 ± 114 | 729 ± 107 | 828 ± 100 |
| 40 wt. % Cr | 60 wt. % FMB | 787 ± 214 | 654 ± 112 | 691 ± 129 |
| 20 wt. % Cr | 80 wt. % FMB | 715 ± 255 | 961 ± 177 | 747 ± 161 |
| 12 wt. % Cr | 50 wt. % FeMo - | 539 ± 155 | 891 ± 204 | 819 ± 146 |
| alloyed | 38 wt % FeB | | | |
| 20 wt. % Cr | 80 wt. % (as 53 | 625 ± 67 | 1136 ± 82 | 1244 ± 183 |
| | wt. % FeMo - | | | |
| | 37 wt. % FeB) | | | |

M4 = M4 Tool steel; Cr = chromium; Ni—Cr = Ni—Cr alloy (80 weight % Ni and 20 weight % Cr); FMB = Fe—Mo—B alloy (62.3 weight % Fe, 28.2 weight % Mo, and 9.5 weight % B); FeB = ferroboron (including 82 weight % iron and 18 weight % boron); FeMo = ferromolybdenum powder (including 60 weight % iron and 40 weight % molybdenum).

Wear-Resistance Testing Data for Compositions of Coating 20

The following table provides ASTM G65B wear-resistance testing data for a number of coating compositions. All samples were cleaned and sprayed under the conditions listed in Example 1. All arc-lamp treatments included two passes at 400 A and 7 mm/s and a third pass at 900 A and 8 mm/s. Arc-lamp heating was performed using a 330,000 Watt arc lamp, and the heating passes as listed with a 25 second delay between each heating pass. The substrate was a case-hardened, low-alloy steel.

Coating compositions and processing conditions may be selected to control the wear-resistance of coating 20. For example, coating 20 may have an ASTM-G65B volume loss less than 20 mm³, less than 10 mm³, or less than 5 mm³.

American Society for Testing and Materials G65-Procedure
B (ASTM-G65B), “Standard Test Method for Measuring Abrasion
Using the Dry Sand/Rubber Wheel Apparatus.”

| Coating Compositions | | Volume |
|---|---|---|
| Matrix Content | Fe—Mo—B Content | Loss, mm³ |
| 60 wt. % M4 | 40 wt. % FMB | 7.0 |
| 40 wt. % M4 | 60 wt. % FMB | 4.0 |
| 20 wt. % M4 | 80 wt. % FMB | 3.8 |
| 60 wt. % 316L | 40 wt. % FMB | 61.9 |
| 40 wt. % 316L | 60 wt. % FMB | 8.3 |
| 20 wt. % 316L | 80 wt. % FMB | 3.5 |
| 40 wt. % 434L | 60 wt. % FMB | 28.0 |
| 20 wt. % 434L | 80 wt. % FMB | 4.0 |
| 40 wt. % NiCr | 60 wt. % FMB | 16.7 |
| 20 wt. % NiCr | 80 wt. % FMB | 3.9 |
| 10 wt. % NiCr | 90 wt. % FMB | 4.5 |
| 80 wt. % Cr | 20 wt. % FMB | 35.9 |
| 60 wt. % Cr | 40 wt. % FMB | 17.2 |
| 40 wt. % Cr | 60 wt. % FMB | 11.0 |
| 20 wt. % Cr | 80 wt. % FMB | 7.0 |
| 50 wt. % Cr alloyed | 50 wt. % (as 53 wt. | 8.6 |
| | % FeMo and 47 wt | |
| | % FeB) | |
| — | 53 wt. % FeMo - 37 | 23.3 |
| | wt. % FeB | |
| 60 wt. % Cr | 40 wt. % (as 53 wt. | 30.0 |
| | % FeMo and 47 wt | |
| | % FeB) | |
| 20 wt. % Cr | 80 wt. % (as 53 wt. | 30.1 |
| | % FeMo and 47 wt | |
| | % FeB) | |

M4 = M4 Tool steel; Cr = chromium; Ni—Cr = Ni—Cr alloy (80 weight % Ni and 20 weight % Cr); FMB = Fe—Mo—B alloy (62.3 weight % Fe, 28.2 weight % Mo, and 9.5 weight % B); FeB = ferroboron (including 82 weight % iron and 18 weight % boron); FeMo = ferromolybdenum powder (including 60 weight % iron and 40 weight % molybdenum).

### INDUSTRIAL APPLICABILITY

The present disclosure describes a coating that may be used with any machine parts that may benefit from the application of a protective coating. The coating may be useful to protect machine parts from wear, deformation, heat, or corrosion.

Coating 20 of the present disclosure may include hard Fe—Mo—B particles 30 dispersed in a ductile matrix 28. Particles 30, having a high hardness value, may provide wear-resistance to coating 20. Matrix phase 28, being softer than particles 30, may absorb coating stresses and form a strong bond with a substrate material 22, at coating-substrate interface region 26. Coating 20 may also provide improved hardness, wear resistance and corrosion protection for numerous machine components.

The formation of coating-substrate interface region 26 of coating 20 may serve to tightly bond coating 20 to substrate 22. For example, in conventional deposition techniques, thermal-expansion stresses may develop between a deposited coating and a substrate due to differences in coefficients of thermal expansion between the coating and substrate materials. Further, solidification stresses can develop between a coating and a substrate when a molten coating material is deposited on a substrate and allowed to solidify. Coating-substrate interface region may serve to alleviate or prevent these thermal-expansion and/or solidification stresses between coating 20 and substrate 22. For example, the metallurgical bond formed by coating-substrate interface region 26, which can have a hardness value less than the hardness value of other portions of coating 20 (e.g., coating surface 24), may absorb and/or alleviate these stresses.

Several other advantages may be realized through use of the presently disclosed coatings and coating methods. For example, the coating compositions used to create coating 20 provide excellent substrate wetting, especially when applied using a thermal-spray processes. Further, the use of arc lamp 32 can be instrumental in the generation of interface region 26 and can, therefore, increase the bonding strength between coating 20 and substrate 22 over other coating treatment techniques. Further, the use of arc-lamp 32, which may be less costly than other types of heat generating devices (e.g., lasers and other devices) can significantly reduce manufacturing costs over systems that include heat generating devices other than arc lamps. Arc-lamp heating can also increase the hardness of coating 20, and therefore, improve wear resistance.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the embodiments disclosed herein. It is intended that the specification and examples be considered as exemplary only, with a true scope of the disclosure being indicated by the following claims and their equivalents.

What is claimed is:

1. A method of producing a wear-resistant coating, comprising:
applying a coating material to a substrate material, wherein the coating material includes a combination of iron, molybdenum, and boron; and
fusing the coating material to the substrate material by heating the coating material with an arc lamp.

2. The method of claim 1, wherein the coating material is applied to the substrate material using a thermal-spray process.

3. The method of claim 1, wherein the coating material includes at least 40 weight percent of the combination of iron, molybdenum, and boron.

4. The method of claim 1, wherein the coating material includes at least 60 weight percent of the combination of iron, molybdenum, and boron.

5. The method of claim 1, wherein the coating material includes at least 80 weight percent of the combination of iron, molybdenum, and boron.

6. The method of claim 1, wherein the coating material further includes steel.

7. The method of claim 6, wherein the steel is selected from the group consisting of tool steel and stainless steel.

8. The method of claim 1, wherein the coating material further includes chromium.

9. The method of claim 1, wherein the coating material further includes an alloy of nickel and chromium.

10. The method of claim 1, wherein the fusing includes passing the arc lamp over a surface of the coating material at a speed of between about 4 mm per second and about 8 mm per second.

11. The method of claim 1, wherein the fusing includes passing the arc lamp over a surface of the coating material from one to five times.

12. The method of claim 1, further including applying ultrasonic vibrations to the substrate material while fusing the coating material with the arc lamp.

13. The method of claim 1, wherein the fusing provides an interface region that bonds a matrix phase to the substrate material.

14. The method of claim 13, wherein a plurality of particles, including iron, molybdenum, and boron, are dispersed in the matrix phase.

15. The method of claim 14, wherein at least some of the plurality of particles include a molybdenum-iron boride phase with the chemical formula Mo₂FeB₂.

16. The method of claim 14 wherein at least some of the plurality of particles include both an iron-boride phase and an iron-molybdenum alloy phase.

17. A method of producing a wear-resistant coating, comprising:
applying a first layer of a coating material having a first composition to a substrate material using a thermal-spray process;
applying a second layer of a coating material having a second composition to the first layer using a thermal-spray process; and
heating the first layer and the second layer with an arc lamp.

18. The method of claim 17, wherein the first coating composition and the second coating composition each include a combination of iron, molybdenum, and boron.

19. The method of claim 18, wherein the first coating composition includes a lower concentration of the combination of iron, molybdenum, and boron than the second coating composition.

20. The method of claim 17, wherein the first layer has a hardness that is less than the hardness of the second layer.

21. The method of claim 17, wherein the first coating composition and the second coating composition each include steel.

22. The method of claim 21, wherein the steel is selected from the group consisting of tool steel and stainless steel.

23. The method of claim 17, wherein the first coating composition and the second coating composition each include chromium.

24. The method of claim 17, wherein the first coating composition and the second coating composition each include an alloy of nickel and chromium.

25. A wear-resistant coating for a substrate, comprising:
a matrix phase;
an interface region bonding the matrix phase to the substrate; and
a plurality of particles dispersed in the matrix phase, wherein at least some of the particles include iron, molybdenum, and boron.

26. The coating of claim 25, wherein at least some of the plurality of particles include a molybdenum-iron boride phase with the chemical formula Mo₂FeB₂.

27. The coating of claim 25, wherein at least some of the plurality of particles include both an iron-boride phase and an iron-molybdenum alloy phase.

28. The coating of claim 25, wherein the matrix phase includes steel.

29. The coating of claim 28, wherein the steel is selected from the group consisting of tool steel and stainless steel.

30. The coating of claim 25, wherein the matrix phase includes chromium.

31. The coating of claim 25, wherein the matrix phase includes an alloy of nickel and chromium.

32. The coating of claim 25, wherein the plurality of particles makes up at least about 40 weight percent of the coating.

33. The coating of claim 25, wherein the plurality of particles makes up at least about 60 weight percent of the coating.

34. The coating of claim 25, wherein the plurality of particles makes up at least about 80 weight percent of the coating.

35. The coating of claim 25, wherein the thickness of the coating is between about 0.2 mm and about 2 mm.

36. The coating of claim 25, wherein the interface region has a thickness between about 50 and 300 microns.

37. The coating of claim 25, wherein the coating has a Vicker's hardness number that is between about 800 and 1400.

28. The coating of claim 25, wherein the coating has an ASTM-G65B volume loss less than 20 mm³.

39. A work machine, comprising:
at least one component having one or more wear surfaces; and
a wear-resistant coating disposed on the one or more wear surfaces of the at least one component,
wherein the wear-resistant coating includes:
a matrix phase;
an interface region bonding the matrix phase to the at least one component; and
a plurality of particles dispersed in the matrix phase,
wherein at least some of the particles include iron, molybdenum, and boron.
